(19) United States
(12) Patent Application Publication
(10) Pub. No.: US 2011/0043085 A1
(43) Pub. Date: Feb. 24, 2011

(54) PORTABLE CONTAINER AND WORKSTATION

(75) Inventor: Jon Parisena, Verdi, NV (US)

Correspondence Address: Jimmy Dong, P. O. Box 601, Verdi, NV, 89439, US

(73) Assignee: SherpaMax LLC, Verdi, NV (US)

(21) Appl. No.: 12/545,629

(22) Filed: Aug. 21, 2009

(51) Int. Cl. A47B 96/00; B62B 1/02; F16D 55/08

(52) U.S. Cl. 312/249.13; 280/47.371; 188/72.9

(57) ABSTRACT

The present invention relates generally to portable workstations and portable tool and equipment containers, and more specifically to single-wheeled portable tool workstations for comfortably, efficiently, and precisely transporting and organizing a tradesman's occupational tools and equipment. A single-wheeled or in-line wheel set portable tool workstation is disclosed that allows for precise and controlled movement over rough and uneven terrain in order to avoid the need for multiple trips between a tradesman's truck or shop and the worksite.

### BRIEF DESCRIPTION OF THE INVENTION

The present invention relates generally to portable workstations and portable tool and equipment containers, and more specifically to single-wheeled or single in-line wheel set portable tool workstations for comfortably, efficiently, and precisely transporting and organizing a tradesman's occupational tools and equipment.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

Portable tool and/or equipment boxes and cabinets are well known in various fields of trade. Contractors, carpenters, electricians, plumbers, mechanics and many other types of tradespersons utilize a wide variety of specialized tools to perform their occupational tasks. Traditionally, these tools are stored in tool/equipment boxes, chests, or cabinets. The boxes, chests, or cabinets may be brought to a worksite in a standard pickup truck or a more specialized trade-specific truck. If the tools/equipment are left in the truck, the tradesperson is required to make many trips back and forth between the parked truck and the worksite to transport all the necessary tools for the job. At the same time, a collection of tools/equipment in a box or chest can be heavy and awkward to transport from the truck to the worksite, and still require many trips. Consequently, persons in the various trades have devised many portable tool/equipment boxes over the years.

U.S. Pat. No. 7,210,689, issued to Edward G. Guirlinger in 2007 (the “Guirlinger tool organizer”), discloses a portable tool organizer comprising a plurality of wheels alongside a frame, the frame enclosing several tool storage panels. The storage panels are each labeled with an identifier for a specific tool so that the user of the tool organizer knows where to place each tool. The labeled panels additionally allow an owner of such an organizer to rent out, or lend out, the tool organizer and then be able to quickly examine the tool organizer upon -return to determine if any tools are missing. The Guirlinger tool organizer is not ideal in that its exemplary embodiment utilizes two wheels on a single axle, a configuration that inhibits user maneuverability of the tool organizer. The two-wheel configuration will not turn sharply and will suffer traveling over rough or uneven terrain. This is a problem because worksites and/or construction sites are often located in areas having rough or uneven terrain.

U.S. Pat. No. 5,518,258, issued to Daryl Cox in 1996 (the “Cox portable workstation”), discloses a compact portable workstation that is designed to store tools in general storage bins and that unfolds into two or more tables or counters, which are intended to be utilized as work surfaces. Similarly to the Guirlinger tool organizer, the Cox portable workstation utilizes a pair of wheels situated on a single axle. As explained, this configuration inhibits user maneuverability by constricting the turning radius of the workstation and by hindering transport across rough and/or uneven terrain.

U.S. Pat. No. 5,224,531, issued Erich Blohm in 1993 (the “Blohm portable shop/toolbox”), discloses a tool storage apparatus that folds to a size appropriate for storage in the bed of a pickup truck and unfolds into a combination saw table, router table and workbench. The Blohm portable shop/toolbox is advantageous in that it provides mounts for power tools and folds into a conveniently portable size for placement in a tradesperson's truck. But the Blohm portable shop/toolbox suffers from the same two wheel/single axle configuration of the Guirlinger tool organizer and the Cox portable workstation.

### BRIEF DESCRIPTION OF THE SEVERAL VIEWS OF THE DRAWING

FIG. 1 illustrates an exemplary embodiment of a single-wheeled portable tool workstation in accordance with the present invention.

FIG. 2 illustrates an alternative embodiment of the single-wheeled portable tool workstation in accordance with the present invention.

FIG. 3A illustrates an exemplary embodiment of the single-wheeled portable tool workstation in its stationary position in accordance with the present invention.

FIG. 3B illustrates an exemplary embodiment of the single-wheeled portable tool workstation while being manually transported by a user in accordance with the present invention.

FIG. 3C illustrates an exemplary embodiment of a single-wheeled portable tool workstation in its upright storage position in accordance with the present invention.

FIG. 3D illustrates an exemplary embodiment of a single-wheeled portable tool workstation tilting while turning in accordance with the present invention.

### DETAILED DESCRIPTION OF THE INVENTION

The herein disclosed single-wheeled portable tool workstation is a highly portable tool and equipment storage apparatus that additionally functions as a workstation when at the desired worksite. Contractors, carpenters, electricians, plumbers, mechanics and many other types of tradespersons (referred to as “tradesmen” or “users” throughout this specification) utilize a wide variety of specialized tools to perform their occupational tasks. The disclosed workstation meets these various types of tradesmen's needs in that it allows them to conveniently store and transport (regardless of the terrain) all of their tools and/or equipment to the worksite at once without multiple trips, and to then physically use the tools and/or equipment in a safe and efficient manner on the work surfaces provided by the workstation.

The disclosed single-wheeled portable tool workstation utilizes a wheelbarrow like structure to facilitate easy transport. A single wheel on an axle is centered and attached to a sturdy shelving structure toward one of the ends (a first end) of the shelving structure. The wheel may be any type of wheel known in the art that is suitable for a wheelbarrow-like apparatus, but is preferably an inflatable rubber or synthetic tire type of wheel. The shelving structure may include one or more compartments, or shelves, designed to house or store the tradesman's various tools and/or equipment. Each of the compartments, or shelves, may be specially designed, shaped, or formed with a particular tool or piece of equipment in mind, and based on the trade performed by the user. For example, one compartment may be specifically designed to hold one or more palm sanders, while a second compartment may be specifically designed to hold an assortment of various size bar clamps. One or more exemplary embodiments of a shelving structure for the herein disclosed single-wheeled portable tool workstation will be discussed in detail below, but any number of configurations will be apparent to those skilled in the art. Regardless of how the shelving structure is configured, two or more lifting and steering poles, or similar protruding members, protrude from the shelving structure at the opposite end (a second end) from the single wheel and axle, and act as handles for the tradesman or user.

When at the worksite and in use as a workstation, the single-wheeled portable tool workstation sits flat on the ground, resting on its single wheel and on the bottom-most surface of the shelving structure. Alternatively, one or more skids may be attached to the underside of the bottom-most surface of the shelving structure. The skid, or skids, may be formed of wood, metal, plastic, or some combination of wood, metal, and/or plastic. The skid(s) may be long and relatively thin members running parallel to the direction of the single-wheel. If multiple skids are utilized, they may be placed parallel to each other in pairs at varying distances from the centerline of the portable tool workstation (the centerline as created by the wheel). The skids can be made to be easily replaced if they wear over time.

For transport to and from the worksite, the single-wheeled portable tool workstation may be held by a user or tradesman by the protruding poles and lifted and rolled along the ground on its single wheel, much like the operation of a wheelbarrow. The user lifts the portable tool workstation's bottom-most surface off of the ground by lifting the two poles, and the weight of the shelving structure and enclosed/attached tools and equipment rests on the single wheel. The user would then use manual force to push or pull the portable tool workstation in the desired direction, resulting in the portable tool workstation rolling on the single wheel.

Alternatively, the shelving structure could be equipped with a motor for turning the wheel and a battery for powering the motor (neither the motor or battery are shown, but their application to a single axle wheel structure would be well known in the art). Wiring from the battery and motor could be run through the shelving structure and one of the poles to a throttle controller at an end. The throttle controller could be configured like the well known traditional motorcycle grip where power is only applied if the user is applying a continuous rotational force on the handle, or configured like the well known snowmobile throttle lever that only applies power while the lever is engaged. Either of this type or other throttle controllers is meant to cut off power to the wheel in the event the user loses their grip of the handle. A breaking mechanism (not shown) could also be applied to the wheel and which enabled the user to apply breaking pressure to the wheel by depressing a handle located on the pole opposite the throttle. Naturally, the breaking mechanism could be included even if the wheel was not motorized so as to prevent gravity from causing the workstation to pick up too much speed and/or momentum going down an incline.

Regardless of whether the workstation is manually powered or motorized, the steering mechanism would work in the same manner. To turn or change directions, the user would tilt the two steering poles in the desired direction. For example, if the user is pushing the portable tool workstation forward and wishes to turn right, the user would tilt the poles to the right by lowering the right-most poll (presumably being controlled by the user's right hand) and lifting the left-most poll (presumably being controlled by the user's left hand). While turning, the entire portable tool workstation would swing or tilt toward that side, much like a motorcycle swings or tilts on its inline wheels during a turn. The single wheel design allows for sharp pivoting on the wheel and therefore allows for relatively sharp turns and changes of direction. For example, the entire portable tool workstation can be almost immediately turned ninety degrees, or even one hundred and eighty degrees, by ceasing forward movement, lifting the shelving structure off the ground via the steering poles, pivoting the shelving structure around the single wheel in contact with the ground, and resuming forward manual force on the lifted steering poles. This allows the workstation to be used at worksites that can only be accessed via narrow passageways, such a twisting hallway leading up to a worksite.

For storage, the single-wheeled portable tool workstation is designed to be relatively compact and versatile, yet hold a large number of tools, instruments and other objects. Despite its large storage capacity, the entire portable tool workstation can fit easily into the bed of a standard American pickup truck while in its natural stationary position (wheel and bottom-most surface on the ground). The portable tool workstation can also be tilted up onto its front surface and stood on-end. While standing on-end, the portable tool workstation takes up much less square-footage, allowing easy storage in tight spaces and travel up and down relatively small utility elevators. A single tradesman could have two or three different workstations, with each one serving a different purpose and still store all of the workstations within the single bed of a truck, either each in the natural stationary position or positioned on end. For example, one workstation could be equipped with a table or band saw and a variety of other tools, while a second workstation could be equipped with a compressor for powering various pneumatic tools and equipment, as well as carrying various additional tools, and a third workstation would be equipped with all of the tools and equipment necessary to do fine carpentry work.

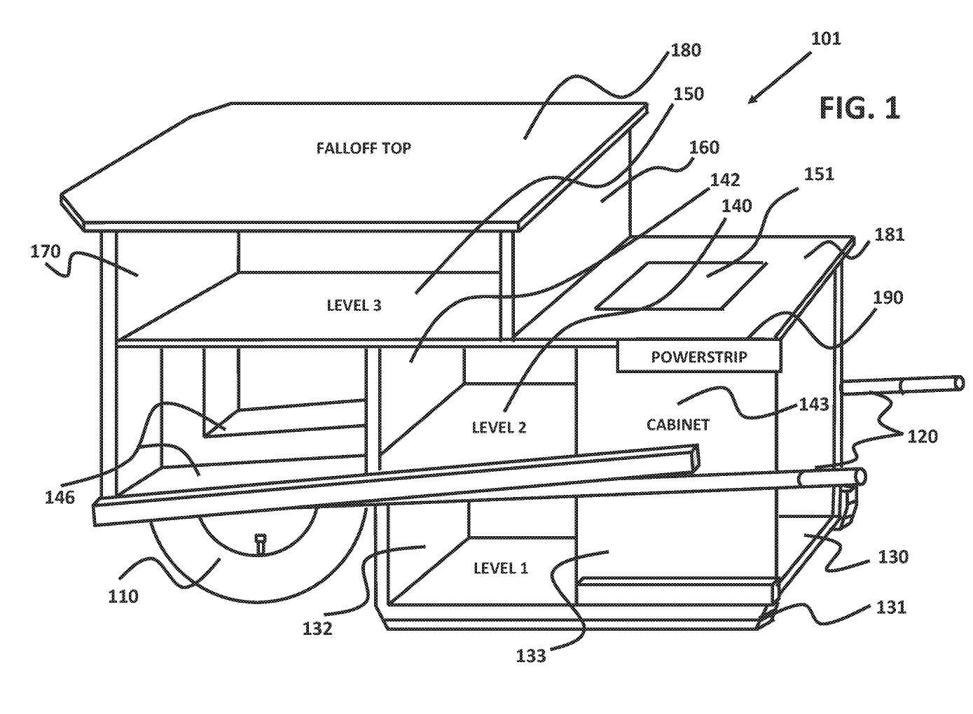

FIG. 1 illustrates an exemplary embodiment of the herein disclosed single-wheeled portable tool workstation 101. Wheel and axle assembly 110 is functionally attached to level 11 surface 140 of the shelving structure, which could be made of wood, metal, plastic or some other suitably attractive yet durable material. Level II surface 140 may be a continuous rectangular board situated above the wheel and axle assembly 110 that allows the wheel of wheel and axle assembly 110 to spin freely below the level II surface 140. Alternatively, the level II surface 140 may be separated into two components (shelves 146 as illustrated in FIG. 1) on either side of an upper portion of the wheel and axle assembly 110, so that the axle of the wheel and axle assembly 110 is below the surface of the shelves 146. In this alternative configuration, the upper portion of the wheel would spin between shelves 146 and protrude into the interior of the shelving structure. In order to prevent water, dirt and other debris from getting into the shelving structure, the upper portion of the wheel may be further contained within a housing built within the level II surface (not shown in FIG. 1). The alternative configuration, with the additional wheel housing, is preferred because it lowers the center of gravity of the workstation and makes it easier to maneuver.

One end of each of the steering poles 120 would protrude from the level II surface 140, while the other end of each pole 120 (hidden in FIG. 1) would be fixedly attached to the shelving structure. Steering poles 120 should protrude away from the shelving structure enough so that a user can grip steering poles 120 and lift the portable tool workstation without having to stand uncomfortably close to the various shelves and/or tools and equipment attached to the portable tool workstation. Steering poles 120 are preferably made of metal or a rigid plastic or fiberglass material that can support the weight of the shelving structure without excessive bending or possibly breaking. Each pole 120 may include a rubber, leather, or another type of textured handgrip at the end held by the user to provide a comfortable and safe grip for the user, and may include a throttle controller and/or break, as described above.

Cabinet 143 may be built onto the level II surface 140 and may include two, three, or even four sides of shelving for tools and/or equipment. The Level I surface 130 is situated vertically below the level II surface 140, as illustrated in FIG. 1. Level I surface 130 is attached to level II surface 140 via wheel back panel 132 and/or level I cabinet 133. Skids 131 may be attached to the underside of level I surface 130. Skids 131 may be one or more relatively long and thin members that protrude from the underside of level I surface 130 and run in parallel to the wheel. The one or more skids 131 may be designed so as to provide stability when the entire portable work station is resting upon them in its stationary working position, while also creating enough traction between the skids 131 and the ground terrain to act as a break to stop the portable tool workstation from rolling away at undesirable times. As previously noted, the skids 131 could be made of a variety of materials and could be readily replaced when worn.

Level III surface 150 is situated vertically above the level II surface 140, as illustrated in FIG. 1. Level III surface 150 is attached to the level II surface 140 via wheel back panel 142 and/or front panel 170 and/or cabinet 143. One or more power strips 190 may be attached to level III surface 150, or any level for that matter. Power strip 190 can be a standard power strip providing a plurality of 3-prong or 2-prong electrical outlets, as is known in the art, with a power cord protruding directly from the strip for connection to a power outlet or extension cord. Alternatively, the power cord for the power strip 190 could be routed through the shelving structure to protrude from some other portion of the workstation that might be less intrusive to the user. The portable tool workstation may have an electrical power plug protruding from any suitable portion of the shelving structure, and once plugged into a power source, can provide multiple outlets at power strip 190 for providing electrical power for the various tool and/or equipment stored therein.

Alternatively, an electrical generator can be stored within a cabinet or shelf of the portable tool workstation, with the power strip 190 functionally coupled to the electricity generator. In this way, power strip 190 can provide electrical power via a plurality of outlets without having to plug into a wall outlet at the worksite. Back panel 160 protrudes upward from the level III surface 150 at approximately the midpoint and, along with front panel 170, provides support for falloff top 180. Falloff top 180 is the upper-most surface of the shelving structure of the herein disclosed single-wheeled portable tool workstation.

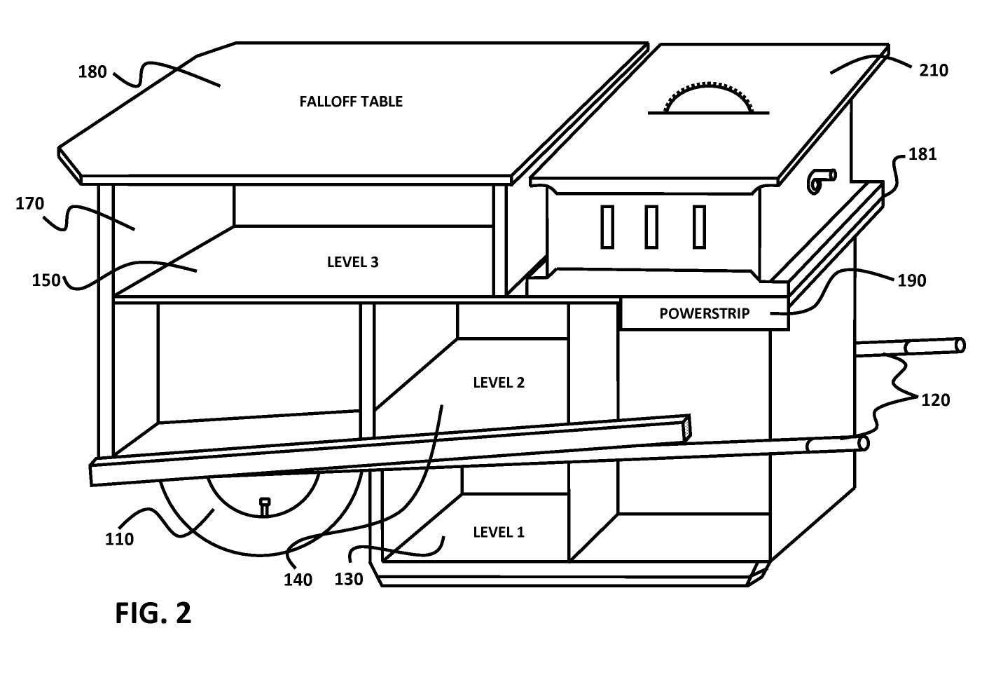

As is apparent in FIG. 1, falloff top 180 may not run the entire length of the level III surface 150, and may have multiple elevations, with an upper elevation designated as 180 and a lower elevation, above cabinet 143, as 181. As illustrated in FIG. 2, this lower elevation provides a place to attach a large power tool, such as table saw 210, so that the upper surface of the tool is on the same plane as the upper elevation surface 180. It may be possible to attach some other large power tool in the gap, such as an electricity generator for example, as will be apparent to those skilled in the art. If a power tool is placed on the lower elevation 181, it may be desirable to place a hole 151, cut into level III surface 150, under the tool to direct debris from the tool into a debris bin stored within cabinet 133.

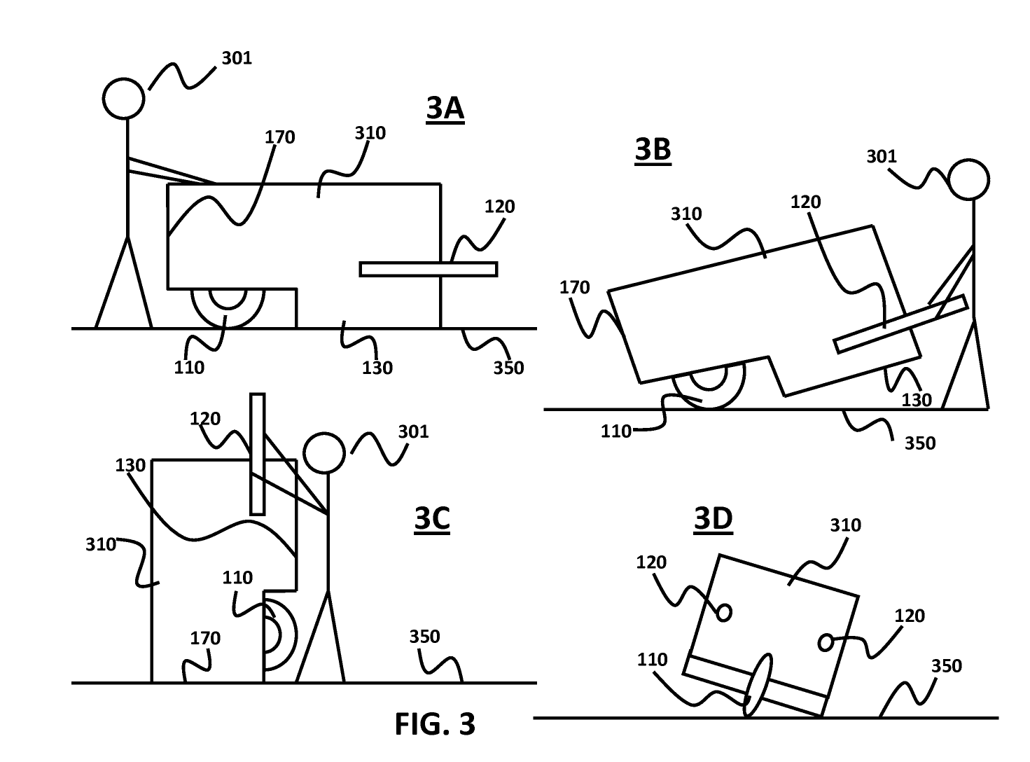

A substantial advantage of the herein disclosed portable tool workstation is that the single-wheel design allows tight and controlled movement by a user. The user or tradesman is able to pivot the tool workstation on the single wheel and is thereby able to make extremely sharp turns. The single wheel also reduces wheel surface area exposed directly to the ground, allowing the user or tradesman to more easily avoid the pitfalls and uneven terrain that is common at worksites. Movement and pivoting of the herein disclosed portable tool workstation is illustrated in FIGS. 3A, 3B, 3C, and 3D.

In order to retain tools and equipment stored within the various cabinets of the workstation, each cabinet may be equipped with a door that either swings or slides open and can be locked closed. Alternatively, the cabinets could be open faced, but provided with raised lips at the out edges to prevent loose objects from falling out. Various hooks and brackets could also be provided within and outside of the cabinet to secure various objects, such as different tools, long levels and clamps and other devices utilized within a particular trade.

Although FIG. 2 is directed to a particular trade that involves utilization of a table saw 210, workstations could be especially designed for many different trades, for general professional use, or for the do-it-yourself consumer at home. For example, one version of the workstation could be designed for a plumber, a second version for an electrician, a third version for a framer or someone who does rough carpentry work, a fourth version for a fine craftsman, a fifth version for a handyman, etc., with each workstation including labels and special locations for placing different tools and equipment unique to the particular trade involved or intended user. A non-inclusive list of the various tools and/or equipment that can be stored in the single-wheeled portable tool workstation includes: a table saw, reciprocating saws and their various blades, a grinder, a router, a belt sander, an orbital sander, a palm sander, a power plainer, a jig saw, a cordless drill, a circle saw, a roto zip, various size bar clamps, various length levels, various drill bits and screw tips, nails and screws, hand tools, framing squares, etc. Those skilled in the art will recognize that almost any tool or piece of equipment of the appropriate size can be attached or stored in the herein disclosed single-wheeled portable tool workstation.

FIG. 3A shows the portable tool workstation in a stationary position at a worksite. User 301 is working with a tool on the work surface provided by shelving structure 310 of the portable tool workstation. Wheel and axle assembly 110 and bottom-most surface 130 rest on the ground 350 and provide stable support for user 301's work on the work surfaces. The shelving structure 310 could also be outfitted with a number of feet or braces that can be retracted into the shelving structure when it is being moved or stored on its end, and extended to the ground 350 to provide additional support when in use or being stored in the stationary position. Furthermore, the feet or braces could be used to level the shelving structure if a flat, level surface is needed for work or to prevent the workstation from tipping over during use.

FIG. 3B shows the portable tool workstation while being moved by user 301's manual force applied to steering poles 120. User 301 lifts shelving structure 310 by gripping steering poles 120 and lifting upward until bottom-most surface 130 if off ground 350. User 301 then applies manual force forward to roll shelving structure 310 along ground 350 on wheel and axle assembly 110. Alternatively, if the workstation is powered by a motor, the user could simply steer the workstation through use of the steering poles 120 and apply power and/or braking as needed to control the speed of the workstation while being moved.

The single-wheeled portable tool workstation can be stored upright (on its end) to reduce the square footage necessary for storage. FIG. 3C illustrates the portable tool workstation being stored upright. User 301 can lift upward on steering poles 120 until wheel and axle assembly 110 is off the ground 350 and the entire portable tool workstation rests on front panel 170 on ground 350. The upright position illustrated in FIG. 3C may also be advantageous for transporting the single-wheeled portable tool workstation in narrow utility or service elevators. As noted above, feet or brackets could also be extended when the workstation is in this position to provide greater stability, and then retracted when in motion.

FIG. 3D illustrates the way in which the single-wheeled portable tool workstation can be turned, or pivoted, quite sharply by a user or tradesman to maneuver the workstation when in motion. As explained above, to turn the workstation while in the process of pushing or pulling it forward, a user can simply lower one steering pole 120 while lifting the opposite steering pole 120. This is illustrated in FIG. 3D by showing the right-most steering pole 120 situated vertically below the left-most steering pole 120. While being turned, the wheel and axle assembly 110 swings, or tilts, much like a motorcycle wheel during a sharp turn. As can be seen from FIG. 3D, while the workstation is turning the wheel and axle assembly 110 tilts into the turn. Such tilting allows for very precise and controlled turning by a user or tradesman.

It should be noted that the single-wheel and axle component of the herein disclosed single-wheeled portable tool workstation could be replaced by a plurality of wheels aligned in a single inline plane. Such a configuration would appear and behave very much like inline-skates, with multiple wheels attached in close proximity all along the same line. Configuring the herein disclosed portable tool workstation with a plurality of wheels in close proximity along the same line or plane would achieve substantially the same benefits as the above described single-wheel, wheelbarrow-like design. A plurality of in-line wheels would allow tight, controlled movement by the tradesman or user due to the user's ability to swing and pivot on the single line of wheels. This specification intends to cover such a portable tool workstation utilizing a plurality of wheels aligned in close proximity along a single plane as an alternative embodiment to the above described single-wheeled portable tool workstation.

While the present invention has been illustrated and described herein in terms of a preferred embodiment and several alternatives associated with single-wheeled portable tool workstation, it is to be understood that the various components of the combination and the combination itself can have a multitude of additional uses and applications. For example, the disclosed portable tool workstations may be used in contexts outside of construction and traditional trades. The disclosed portable tool workstation can be fitted with various crafting materials (such as beads, threads, and paper, for example) and used at street fairs or carnivals, for example. Accordingly, the invention should not be limited to just the particular descriptions and various drawing figures contained in this specification that merely illustrate one or more preferred embodiments and applications of the principles of the invention.

What is claimed is:

1. A portable container and workstation, comprising:
a shelving structure including a first end, a second end, and one or more shelves between the first end and the second end holding one or more objects;
an axle assembly attached to the shelving structure toward the first end;
a wheel supported by the axle assembly about which the portable container and workstation can pivot and move; and
two elongated poles protruding from the second end of the shelving structure for enabling a user to steer movement of the portable container and workstation.

2. The portable container and workstation as recited in claim 1, wherein a first pole of the two elongated poles includes a first handle for a user, wherein a second pole of the two elongated poles includes a second handle for the user, and further comprising:
a motor affixed to the shelving structure driving the wheel;
a power source affixed to the shelving structure providing power to the motor;
a throttle controller coupled to the motor affixed to the first handle controlling the motor;
a brake mechanism applying a braking force to the wheel and
a brake handle coupled to the brake mechanism affixed to the first handle or the second handle controlling the brake mechanism.

3. The portable container and workstation as recited in claim 1, wherein a first pole of the two elongated poles includes a first handle for a user, and further comprising:
a brake mechanism applying a braking force to the wheel and
a brake handle coupled to the brake mechanism affixed to the first handle controlling the brake mechanism.

4. The portable container and workstation as recited in claim 1, wherein the one or more shelves include an upper shelf that functions as a work surface for a user and to which the one or more objects can be affixed.

5. The portable container and workstation as recited in claim 4, wherein the upper shelf has a first elevation and a second elevation.

6. The portable container and workstation as recited in claim 5, wherein the first elevation is higher than the second elevation, wherein an object among the one or more objects is affixed to the second elevation, the object having an upper surface that is planar with the first elevation.

7. The portable container and workstation as recited in claim 1, further comprising one or more power strips having one or more electrical outlets affixed to the shelving structure.

8. The portable container and workstation as recited in claim 7, wherein the one or more objects include an electricity generator electrically connected to the one or more power strips.

9. The portable container and workstation as recited in claim 1, wherein the shelving structure includes one or more cabinets for holding the one or more objects.

10. The portable container and workstation as recited in claim 9, wherein the shelving structure is configured for a trade or a type of job to be performed by a user.

11. The portable container and workstation as recited in claim 1, wherein the shelving structure is sized to fit within a bed of a standard-sized truck.

12. The portable container and workstation as recited in claim 1, wherein the shelving structure includes a front panel, and wherein the portable container and workstation may be rotated on the front panel to rest upright during storage.

13. The portable container and workstation as recited in claim 1, wherein the shelving structure includes a first level shelf surface storing one or more objects and a second level shelf storing one or more objects positioned above at least a portion of the first level shelf, the first shelf having an underside upon which the portable container and workstation rests when not moving, the underside including one or more skids.

14. The portable container and workstation as recited in claim 1, wherein the two elongated poles are affixed to the shelving structure.

15. The portable container and workstation as recited in claim 1, wherein the wheel includes an inflated tire.

16. The portable container and workstation as recited in claim 1, wherein the one or more objects are selected from the group of a table saw, a reciprocating saw, a grinder, a router, a belt sander, an orbital sander, a palm sander, a power plainer, a jig saw, a drill, a circle saw, a roto zip, a bar clamp, a level, a drill bit, a screw tip, a nail, a screw, or a framing square.

17. A portable container and workstation, comprising:
a shelving structure including a first end, a second end, and one or more shelves between the first end and the second end holding one or more objects;
a wheel and axle assembly attached to the shelving structure toward the first end, the wheel and axle assembly including a plurality of in-line wheels about which the portable container and workstation can pivot and move; and
two poles protruding from the second end of the shelving structure for enabling a user to steer movement of the portable container and workstation.

18. The portable container and workstation as recited in claim 17, wherein a first pole of the two poles includes a first handle for a user, wherein a second pole of the two poles includes a second handle for the user, and further comprising:
a motor affixed to the shelving structure driving the plurality of in-line wheels;
a power source affixed to the shelving structure providing power to the motor;
a throttle controller coupled to the motor affixed to the first handle controlling the motor;
a brake mechanism applying a braking force to the plurality of in-line wheels and
a brake handle coupled to the brake mechanism affixed to the first handle or the second handle controlling the brake mechanism.

19. The portable container and workstation as recited in claim 17, wherein a first pole of the two poles includes a first handle for a user, and further comprising:
a brake mechanism applying a braking force to the plurality of in-line wheels; and
a brake handle coupled to the brake mechanism affixed to the first handle controlling the brake mechanism.

20. The portable container and workstation as recited in claim 17, wherein the one or more shelves include an upper shelf that functions as a work surface for a user and to which the one or more objects can be affixed.

21. The portable container and workstation as recited in claim 20, wherein the upper shelf has a first elevation and a second elevation.

22. The portable container and workstation as recited in claim 21, wherein the first elevation is higher than the second elevation, wherein an object among the one or more objects is affixed to the second elevation, the object having an upper surface that is planar with the first elevation.

23. The portable container and workstation as recited in claim 17, further comprising one or more power strips having one or more electrical outlets affixed to the shelving structure.

24. The portable container and workstation as recited in claim 23, wherein the one or more objects include an electricity generator electrically connected to the one or more power strips.

25. The portable container and workstation as recited in claim 17, wherein the shelving structure includes one or more cabinets for holding the one or more objects.

26. The portable container and workstation as recited in claim 25, wherein the shelving structure is configured for a trade or a type of job to be performed by a user.

27. The portable container and workstation as recited in claim 17, wherein the shelving structure is sized to fit within a bed of a standard-sized truck.

28. The portable container and workstation as recited in claim 17, wherein the shelving structure includes a front panel, and wherein the portable container and workstation may be rotated on the front panel to rest upright during storage.

29. The portable container and workstation as recited in claim 17, wherein the shelving structure includes a first level shelf surface storing one or more objects and a second level shelf storing one or more objects positioned above at least a portion of the first level shelf, the first shelf having an underside upon which the portable container and workstation rests when not moving, the underside including one or more skids.
